(19) United States
(12) Patent Application Publication
(10) Pub. No.: US 2016/0077402 A1
(43) Pub. Date: Mar. 17, 2016

(54) LIQUID CRYSTAL LENS, LAMP DEVICE, LIGHTING DEVICE AND LIQUID CRYSTAL LENS DEVICE

(71) Applicant: Panasonic Intellectual Property Management Co., Ltd., Osaka (JP)

(72) Inventors: Kosuke TAKEHARA, Osaka (JP); Koji OMURA, Osaka (JP)

(21) Appl. No.: 14/839,898

(22) Filed: Aug. 28, 2015

(30) Foreign Application Priority Data
Sep. 11, 2014 (JP) 2014185552

(51) Int. Cl. G02F 1/29; G02F 1/137; G02F 1/1343

(52) U.S. Cl. CPC G02F 1/29; G02F 1/13439; G02F 1/137

(57) ABSTRACT

A liquid crystal lens includes a first transparent substrate, a second transparent substrate, a liquid crystal layer disposed between the first transparent substrate and the second transparent substrate, a first transparent electrode disposed between the first transparent substrate and the liquid crystal layer and second transparent electrodes disposed between the second transparent substrate and the liquid crystal layer and facing the first transparent electrode. At least one second transparent electrode of the second transparent electrodes is disposed in each of divided regions into which a surface region, facing the first transparent substrate, of the second transparent substrate is divided.

### CROSS-REFERENCE TO RELATED APPLICATIONS

The application is based upon and claims the benefit of priority of Japanese Patent Application No. 2014-185552, filed on Sep. 11, 2014, the entire contents of which are incorporated herein by reference.

### TECHNICAL FIELD

The invention relates to a liquid crystal lens, a lamp device, a lighting device, and a liquid crystal lens device.

### BACKGROUND ART

JP S62-140603 U (hereinafter, referred to as “Document 1”) discloses a light projector capable of adjusting the distribution of light. The light projector of Document 1 includes a light source, a reflector and a condensing lens. In this light projector, the condensing lens is constituted by a liquid crystal lens of which focal length is variable according to applied AC voltage.

Document 1 mentions that the radiation distance (beam range) and the radiation area (beam width) of the light projector can be adjusted by changing the focal length of the liquid crystal lens.

In recent years, in the field of lamp such as a headlight for vehicle, there is an increasing demand for a lamp capable of adjusting light distribution thereof.

Also, there is an increasing demand for a headlight for vehicle capable of adjusting its radiation distance and its radiation area in wider range.

### SUMMARY

It is an object of the present invention to provide a liquid crystal lens, a lamp device, a lighting device and a liquid crystal lens device capable of providing higher flexible adjustment to light distribution.

A liquid crystal lens according to an aspect of the invention includes a first transparent substrate, a second transparent substrate, a liquid crystal layer, a first transparent electrode and second transparent electrodes. The liquid crystal layer is disposed between the first transparent substrate and the second transparent substrate. The first transparent electrode is disposed between the first transparent substrate and the liquid crystal layer. The second transparent electrodes are disposed between the second transparent substrate and the liquid crystal layer and face the first transparent electrode with the liquid crystal layer interposed therebetween. At least one second transparent electrode of the second transparent electrodes is disposed in each of divided regions into which a surface region, facing the first transparent substrate, of the second transparent substrate is divided.

A lamp device according to an aspect of the invention includes a light source, and a lens for adjusting distribution of light from the light source. The lens is the liquid crystal lens described above.

A lighting device according to an aspect of the invention includes the lamp device, and a control unit configured to control a planar distribution of an electric field to be applied to the liquid crystal lens.

A liquid crystal lens according to an aspect of the invention includes the liquid crystal lens, a driver configured to apply voltages between the second transparent electrodes and the first transparent electrode, individually; and a control unit configured to control the driver.

### BRIEF DESCRIPTION OF THE DRAWINGS

Preferred embodiments of the invention will now be described in further details. Other features and advantages of the present invention will become better understood with regard to the following detailed description and accompanying drawings where:

FIG. 1A is a schematic section of a liquid crystal lens according to Embodiment 1, FIG. 1B is a schematic planar view of a second transparent substrate and second transparent electrodes viewed from a side of a first transparent substrate, in the liquid crystal lens according to Embodiment 1, and FIG. 1C is a schematic planar view of the first transparent substrate and a first transparent electrode viewed from a side of the second transparent substrate, in the liquid crystal lens according to Embodiment E

FIG. 2A is a view illustrating a layout of the second transparent electrodes on a surface of the second transparent substrate in the liquid crystal lens according to Embodiment 1, and FIG. 2B is another view illustrating the layout of the second transparent electrodes on the surface of the second transparent substrate in the liquid crystal lens according to Embodiment 1;

FIGS. 3A and 3B are views illustrating the general principle of a liquid crystal lens;

FIGS. 4A and 4B are views illustrating the general principle of a liquid crystal lens;

FIG. 5 is a schematic view illustrating the distribution of light from a lamp device that includes the liquid crystal lens according to Embodiment E

FIG. 6 is a schematic section of the lamp device according to Embodiment 1;

FIG. 7 is a schematic planar view of a light source provided in the lamp device according to Embodiment 1;

FIG. 8 is a schematic planar view illustrating positional relation between the liquid crystal lens and the light source, in the lamp device according to Embodiment E

FIG. 9 shows a schematic configuration of a control system that includes a lighting device according to Embodiment E

FIG. 10A is a view illustrating a vehicle attitude, FIG. 10B is a view for showing second transparent electrodes, to which voltages are to be applied, in the liquid crystal lens when the vehicle attitude is as shown in FIG. 10A, and FIG. 10C is a schematic view illustrating a state of the liquid crystal lens;

FIG. 11A is a view illustrating a vehicle attitude, FIG. 11B is a view for showing second transparent electrodes, to which voltages are to be applied, in the liquid crystal lens when the vehicle attitude is as shown in FIG. 11A, and FIG. 11C is a schematic view illustrating a state of the liquid crystal lens;

FIG. 12A is a view illustrating a vehicle attitude, FIG. 12B is a view for showing second transparent electrodes, to which voltages are to be applied, in the liquid crystal lens when the vehicle attitude is as shown in FIG. 12A, and FIG. 12C is a schematic view illustrating a state of the liquid crystal lens;

FIG. 13 is a schematic view illustrating the light distribution of main-beam headlights when a vehicle enters a right curve in the road;

FIG. 14A is a view for showing second transparent electrodes, to which voltages are to be applied, in the liquid crystal lens when a vehicle enters a right curve in the road; and FIG. 14B is a schematic view illustrating a state of the liquid crystal lens;

FIG. 15 is a schematic view illustrating the light distribution of main-beam headlights when vehicles travel in opposite directions;

FIG. 16A is a schematic view illustrating the light distribution of a right main-beam headlight when there is no need to deal with oncoming traffic, and FIG. 16B is a schematic view illustrating the light distribution of a right main-beam headlight when there is a need to deal with oncoming traffic;

FIG. 17A is a view for showing second transparent electrodes, to which voltages are to be applied, in a left main-beam headlight when vehicles travel in opposite directions, and FIG. 17B is a view for showing second transparent electrodes, to which voltages are to be applied, in a right main-beam headlight when vehicles travel in opposite directions;

FIG. 18A is a schematic view illustrating a state of the liquid crystal lens in the left main-beam headlight when vehicles travel in opposite directions, and FIG. 18B is a schematic view illustrating a state of the liquid crystal lens in the right main-beam headlight when vehicles travel in opposite directions;

FIG. 19 is a schematic section of a lamp device according to Embodiment 2;

FIG. 20 is a schematic section of a lamp device according to Embodiment 3;

FIG. 21 is a schematic section of a lamp device according to Embodiment 4;

FIG. 22 is a schematic view of a liquid crystal lens device according to Embodiment E and

FIG. 23 is a view illustrating a pretilt angle of a liquid crystal molecule.

### DESCRIPTION OF EMBODIMENTS

Attached figures illustrate schematic configurations of Embodiments 1 to 4, and illustrated dimension ratios, such as ratios of length and thickness, of constituent elements do not always reflect actual dimensional ratios. Materials, numerical values and the like recited in Embodiments 1 to 4 are mere preferable examples, and not limited thereto.

### Embodiment 1

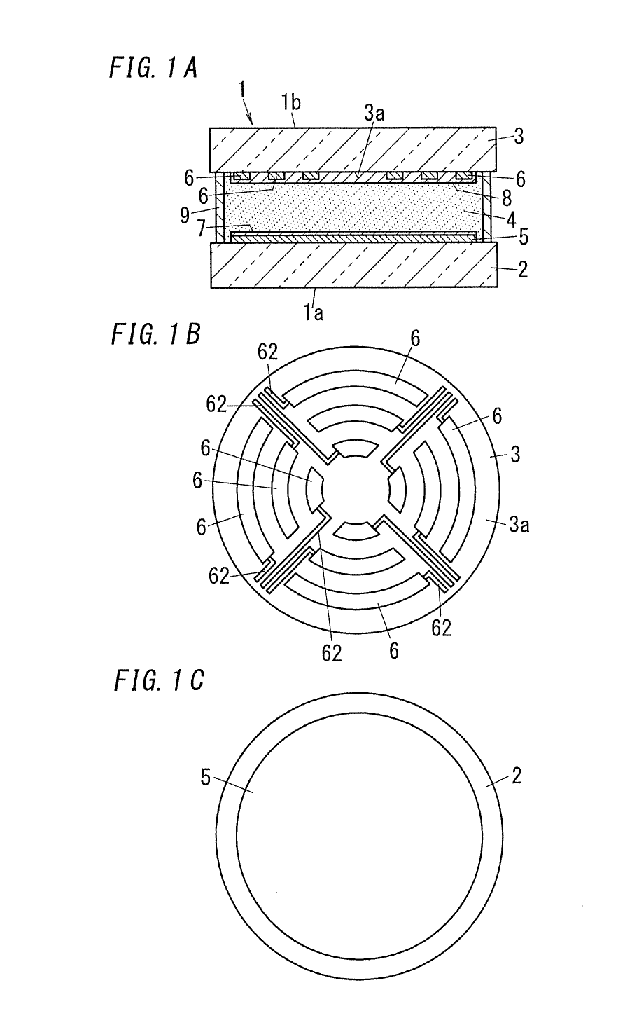

A liquid crystal lens 1 and a liquid crystal lens device 1000 according to the present embodiment are explained with reference to FIGS. 1A to 1C, 2A, 2B, 3A, 3B, 4A, 4B 22, and 23.

The liquid crystal lens 1 is an optical device (photonic device) configured to adjust (change) distribution of rays of light from a light source, by means of refraction effects occurring at a surface (first surface) 1a to which rays of light strike and a surface (second surface) 1b from which rays of light emerge, and in the liquid crystal layer 4, and the like. When a light enters a birefringent material (the liquid crystal layer 4, in the embodiment) and the light may be split into two rays, one of them is called ordinary rays whose velocity within the material are the same in any directions, and the other of them are called extraordinary rays whose velocity within the material vary according to the propagating directions thereof. The extraordinary ray, of the extraordinary and ordinary rays, can be adjusted by the crystal lens 1. The “birefringence” is a property responsible for a phenomenon of double refraction in which, when a ray of light enters a birefringent material (the liquid crystal layer 4, in the embodiment), the ray is split into two rays of light having vibration directions orthogonal to each other. Specifically, in the liquid crystal lens 1, the liquid crystal layer 4 has refractive index anisotropy due to the dielectric constant anisotropy of crystal molecules 4a, and thus rays of light having different polarizations see different refractive indices. In other words, the liquid crystal lens 1 is a lens capable of adjusting its light scattering properties by changing distribution of electric field applied in the liquid crystal layer 4. The liquid crystal lens 1 is a voltage driving type photonic device. The liquid crystal layer 4 has a birefringence (Δn). The birefringence Δn is represented by a formula Δn=nₑ−nₒ, where “nₑ” denotes an extraordinary refractive index and “nₒ” denotes an ordinary refractive index.

The liquid crystal lens 1 includes a first transparent substrate 2, a second transparent substrate 3, a liquid crystal layer 4, a first transparent electrode 5, and second transparent electrodes 6. The second transparent substrate 3 faces the first transparent substrate 2. The liquid crystal layer 4 is disposed between the first transparent substrate 2 and the second transparent substrate 3. The first transparent electrode 5 is disposed between the first transparent substrate 2 and the liquid crystal layer 4. The second transparent electrodes 6 are disposed between the second transparent substrate 3 and the liquid crystal layer 4, and face the first transparent electrode 5 via the liquid crystal layer 4. At least one second transparent electrode 6 of the second transparent electrodes 6 is disposed in each of divided regions 3ab into which a surface region 3a, facing the first transparent substrate 2, of the second transparent substrate 3 is divided. Accordingly, the liquid crystal lens 1 can provide an improved flexible adjustment to light distribution.

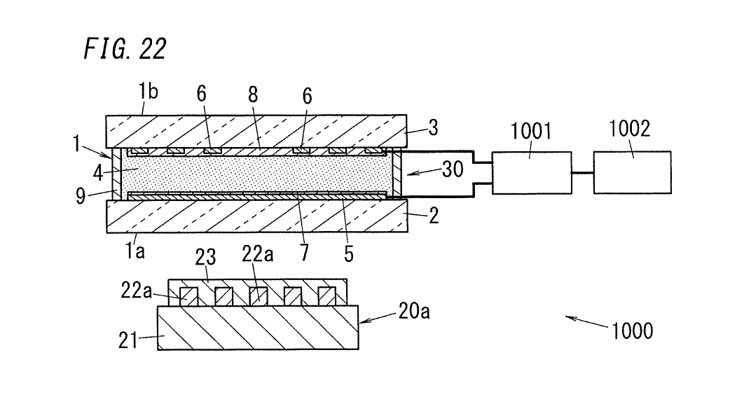

As shown in FIG. 22, the liquid crystal lens device 1000 includes the liquid crystal lens 1, a driver 1001 and a controller 1002. For example, the driver 1001 is configured to apply voltages between the second transparent electrodes 6 and the first transparent electrode 5, individually. The controller 1002 is configured to control the driver 1001.

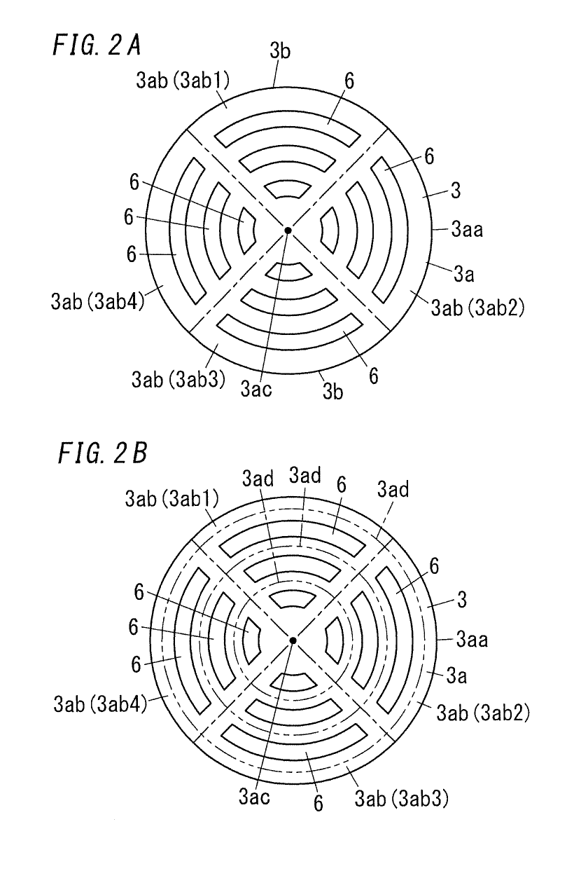

In more detail, the liquid crystal lens 1 is configured so that (a) voltage(s) can be applied between the first transparent electrode 5 as a ground and at least one second transparent electrode 6 of at least one divided region 3ab of the divided regions from an outside (e.g., from the driver 1001), for example. Accordingly, with the liquid crystal lens 1, for example, it is possible to adjust (change) orientations of liquid crystal molecules 4a in each region of the liquid crystal layer 4, which corresponds to one of the divided regions 3ab. Accordingly, the liquid crystal layer 4 can provide various states of orientation of the liquid crystal molecules 4a. The liquid crystal lens 1 thus can provide an enhanced flexible adjustment to light distribution. In the liquid crystal lens 1, it is possible to increase the flexibility in selecting combinations of the first transparent electrode 5 and second transparent electrode(s) 6 between which the voltage is applied. In FIGS. 2A and 2B, each boundary between adjacent divided regions 3ab is drawn by a dashed-dotted line.

As shown in FIG. 1A, in the liquid crystal lens 1, preferably, the liquid crystal layer 4 is enclosed by the first transparent substrate 2, the second transparent substrate 3, and a connection portion 9 disposed between a periphery of the first transparent substrate 2 and a periphery of the second transparent substrate 3.

Preferably, the liquid crystal lens 1 includes a first alignment film 7, and a second alignment film 8. With this configuration, the liquid crystal lens 1 has an enhanced controlling performance of orientation adjustment. The first alignment film 7 covers the first transparent electrode 5. The first alignment film 7 is disposed between the first transparent electrode 5 and the liquid crystal layer 4. The second alignment film 8 covers the second transparent electrodes 6. The second alignment film 8 is disposed between the second transparent electrodes 6 and the liquid crystal layer 4.

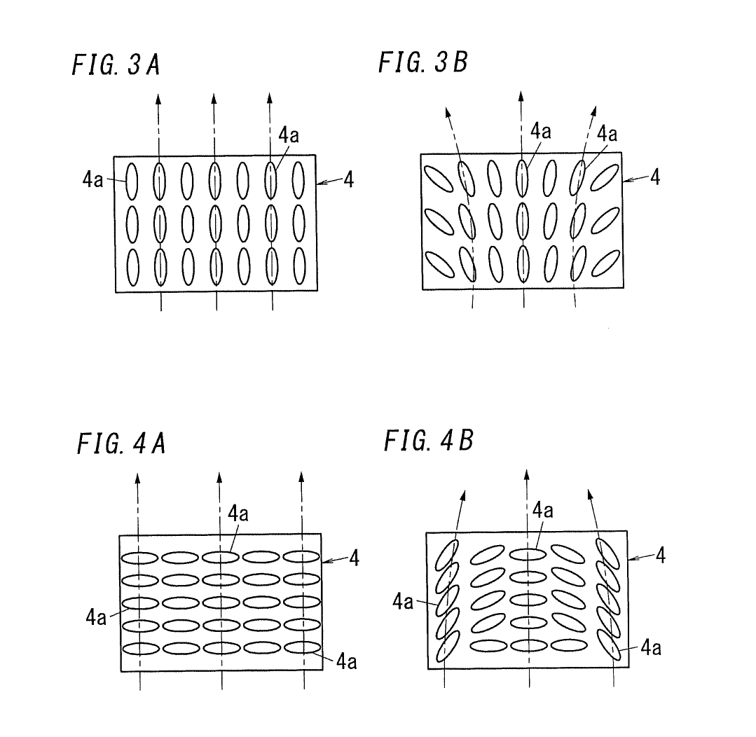

In the liquid crystal lens 1, orientations of the liquid crystal molecules 4a in the liquid crystal layer 4 can be aligned as shown in FIGS. 3A and 4A, by the first alignment film 7 and the second alignment film 8. In the liquid crystal lens 1, when an electric field is applied to the liquid crystal layer 4, the liquid crystal molecules 4a turn (rotate) according to the applied electric field, and as a result the extraordinary refractive index of the liquid crystal layer 4 changes. Therefore, the liquid crystal lens 1 can function as a gradient index (GRIN) lens. The GRIN lens is a lens constituted by optical medium having a gradual variation of refractive index. FIG. 3A shows a liquid crystal layer 4 in which liquid crystal molecules 4a are aligned in the homeotropic alignment. The homeotropic alignment is a state where long axes of the liquid crystal molecules 4a align substantially perpendicular to the first transparent substrate 2 and the second transparent substrate 3. FIG. 4A shows a liquid crystal layer 4 in which liquid crystal molecules 4a are aligned in the homogeneous alignment. The homogeneous alignment is a state where long axes of the liquid crystal molecules 4a align substantially in parallel to the first transparent substrate 2 and the second transparent substrate 3 and align in one direction. For example, liquid crystal molecules 4a having negative dielectric anisotropy are aligned in the homeotropic alignment, as shown in FIG. 3A. Liquid crystal molecules 4a having positive dielectric anisotropy are aligned in the homogeneous alignment, as shown in FIG. 4A. FIG. 3B shows an example of oriented state of the liquid crystal molecules 4a when an electric field is applied to the liquid crystal layer 4 of FIG. 3A. FIG. 4B shows an example of oriented state of the liquid crystal molecules 4a when an electric field is applied to the liquid crystal layer 4 of FIG. 4A. Dashed-dotted arrows in FIGS. 3A, 3B, 4A and 4B indicate schematic examples of rays of light propagating through the liquid crystal layer 4. Note that, the dielectric anisotropy Δ∈ is represented by a formula of Δ∈=∈_{∥}−∈^{⊥}, where ∈_{∥}, denotes the dielectric constant in a direction parallel to the long axis of the liquid crystal molecule 4a, and ∈^{⊥} denotes the dielectric constant in a direction perpendicular to the long axis of the liquid crystal molecule 4a. “Negative dielectric constant” means Δ∈<0, and “positive dielectric constant” means Δ∈>0.

Components of the liquid crystal lens 1 will be explained in more detail below.

Each of the first transparent substrate 2 and the second transparent substrate 3 is optically transparent. Each of the first transparent substrate 2 and the second transparent substrate 3 has, in a visible light range, a total luminous transmittance of preferably 60% or more, further preferably 70% or more, and yet further preferably 80% or more. The total luminous transmittance can be determined according to a method defined in ISO 13468-1.

Each of the first transparent substrate 2 and the second transparent substrate 3 may be a glass substrate or the like. Examples of material of the glass substrate include soda glass, alkali-free glass and the like. In other words, examples of material of the first transparent substrate 2 and the second transparent substrate 3 include soda glass, alkali-free glass and the like. In the liquid crystal lens 1, preferably, the first transparent substrate 2 and the second transparent substrate 3 are made of the same material, but not limited thereto. The first transparent substrate 2 and the second transparent substrate 3 may be made of different materials.

The first transparent substrate 2 has a circular peripheral shape. The second transparent substrate 3 has a circular peripheral shape. In the liquid crystal lens 1, the first transparent substrate 2 and the second transparent substrate 3 have the same diameter, but not limited thereto.

Each of the first transparent electrode 5 and the second transparent electrode 6 is electrically conductive and optically transparent. Each of the first transparent electrode 5 and the second transparent electrode 6 may be a transparent conductive layer, for example.

Examples of material of the transparent conductive layer include transparent conducting oxide (TCO) and the like. Examples of TCO include indium tin oxide (ITO), aluminum-doped zinc-oxide (AZO), gallium-doped zinc-oxide (GZO), indium zinc oxide (IZO), fluorine-doped tin oxide (FTO) and the like. The transparent conductive layer may be, for example, a stack structure including a transparent conducting oxide layer and a metal layer with a thickness of 10 nm or less. The transparent conductive layer has, in a visible light range, a total luminous transmittance of preferably 60% or more, further preferably 70% or more, and yet further preferably 80% or more. The total luminous transmittance can be determined according to a method defined in ISO 13468-1.

The first transparent electrode 5 has a circular peripheral shape. The first transparent electrode 5 has a diameter smaller than the diameter of the first transparent substrate 2. Preferably, the first transparent substrate 2, the liquid crystal layer 4 and the second transparent substrate 3 have common centers through which a center line parallel to the thickness direction of the liquid crystal lens 1 passes. Details of the second transparent electrodes 6 are described later.

The liquid crystal layer 4 is made of liquid crystal material including liquid crystal molecules 4a of which orientations are varied according to an applied electric filed. In other words, orientations of the liquid crystal molecules 4a in the liquid crystal layer 4 are changed according to the applied electric field, and the birefringence of the liquid crystal layer 4 varies according to the orientations of the liquid crystal molecules 4a. The electric filed applied in the liquid crystal layer 4 can be changed by changing voltages across the first transparent electrode 5 and the second transparent electrodes 6. The liquid crystal material may be nematic liquid crystal, for example. The liquid crystal layer 4 shown in FIG. 3A may be made of the nematic liquid crystal in the homeotropic alignment. The liquid crystal layer 4 shown in FIG. 4A may be made of the nematic liquid crystal in the homogeneous alignment. The birefringence of the liquid crystal layer 4 in the liquid crystal lens 1 is controlled by the electric filed applied thereto.

The connection portion 9 is made of adhesive, for example. Preferably, the connection portion 9 is waterproofing. With this property, the liquid crystal lens 1 has an improved water-resistance. Material for the connection portion 9 is resin, for example. Examples of the resin include thermosetting resin, ultraviolet curable resin, and the like. In more detail, for example, thermosetting epoxy resin, ultraviolet curable epoxy resin may be employed as the resin.

The connection portion 9 may be made of resin containing hygroscopic material. Preferably, the hygroscopic material is alkaline-earth metal oxide and/or sulfate. Examples of the alkaline-earth metal oxide include calcium oxide, barium oxide, magnesium oxide, strontium oxide, and the like. Examples of the sulfate include lithium sulfate, sodium sulfate, gallium sulfate, titanium sulfate, nickel sulfate, and the like. Other examples of the hygroscopic material include calcium chloride, magnesium chloride, copper chloride, magnesium oxide, and the like. Also, organic compounds having hygroscopicity, such as silica gel, polyvinyl alcohol and the like may be employed as the hygroscopic material.

The first alignment film 7 and the second alignment film 8 have a function of regularly arranging the liquid crystal molecules 4a under initial state where electric field is not applied to the liquid crystal layer 4. “Regularly arranging the liquid crystal molecules 4a” indicates aligning long axes of the liquid crystal molecules 4a in one direction, as shown in FIGS. 3A and 4A, under the initial state where electric field is not applied to the liquid crystal layer 4. Each of the first alignment film 7 and the second alignment film 8 may be an alignment film made of organic material (hereinafter, referred to as “organic alignment film”), or an alignment film made of inorganic material (hereinafter, referred to as “inorganic alignment film”). The organic material for the organic alignment film may be polymeric material such as polyimide. The inorganic material for the inorganic alignment film may be SiO₂. The organic alignment film is preferably employed as each of the first alignment film 7 and the second alignment film 8. Preferably, the organic alignment film is subject to an orientation treatment according to the rubbing method or the like.

As described above, at least one second transparent electrode 6 of the second transparent electrodes 6 is disposed in each of divided regions 3ab into which a surface region 3a, facing the first transparent substrate 2, of the second transparent substrate 3 is divided. In other words, the second transparent electrodes 6 are disposed on divided regions 3ab into which the surface 3a is divided.

As shown in FIG. 2A, the divided regions 3ab respectively have circular sector shapes into which a circle 3aa is divided, as shown in FIG. 2A. Preferably, in each of the divided regions 3ab, two or more second transparent electrodes 6 of the second transparent electrodes 6 are arranged along a radial direction of the circle 3aa. Preferably, in each of the divided regions 3ab, the two or more second transparent electrodes 6 are shaped like arcs along an arc 3b of its own circular sector shape, and have longer arc lengths as their own positions are closer to the arc 3b of its own circular sector shape. Accordingly, the liquid crystal lens 1 has a further enhanced controlling performance of the light distribution. In the example of FIG. 2A, three second transparent electrodes 6 are disposed in each divided region 3ab, but the number of the second transparent electrodes 6 is not limited to three, and may be two or more.

In a specific example, as shown in FIG. 2A, the divided regions 3ab include first to fourth regions 3ab1 to 3ab4 respectively have quadrant shapes into which the circle 3aa is divided equally. In each of the first to fourth regions 3ab1 to 3ab4, two or more second transparent electrodes 6 of the second transparent electrodes 6 are arranged along a radial direction of the circle 3aa. In each of the first to fourth regions 3ab1 to 3ab4, the two or more second transparent electrodes 6 are shaped like arcs along an arc of its own quadrant shape, and have longer arc lengths as their positions are closer to the arc of its own quadrant shape.

From another perspective, four second transparent electrodes 6 of the second transparent electrodes 6 are disposed in each concentric circle regions 3ad having common centers, on the surface 3a of the second transparent substrate 3. In each concentric circle region 3ad, the four second transparent electrodes 6 are disposed with even spaces. The number of second transparent electrodes 6 in one concentric circle region 3ad is the same as the number of divided regions 3ab (i.e., four). Also, the four second transparent electrodes 6 in one concentric circle region 3ad are disposed in different divided regions 3ab. Accordingly, the liquid crystal lens 1 can provide easy designing, while providing higher flexible adjustment to light distribution.

The second transparent electrodes 6 are connected to respective wirings 62. Preferably, the wirings 62 are made of the same material as the second transparent electrodes 6. Accordingly, in the liquid crystal lens 1, it is possible to prevent rays of light from being reflected or absorbed by the wirings 62.

The liquid crystal lens 1 includes a first terminal to which the first transparent electrode 5 is electrically connected. In an example, the second transparent electrodes 6 are electrically connected to second terminals via the wirings 62 so that two or more second transparent electrodes 6 in each divided region 3ab is electrically connected to a common second terminal, and second transparent electrodes 6 in different divided regions 3ab are electrically connected to different second terminals. In the liquid crystal lens 1, for example, a wiring 62 and a second terminal are electrically connected to each other with a through-hole wiring penetrating the second transparent substrate 3 in the thickness direction of the second transparent substrate 3. In each divided region 3ab in the liquid crystal lens 1, the two or more second transparent electrodes 6 may be electrically connected to different second terminals. In the liquid crystal lens 1, the second transparent electrodes 6 may be electrically connected to respective second terminals in one-to-one relation.

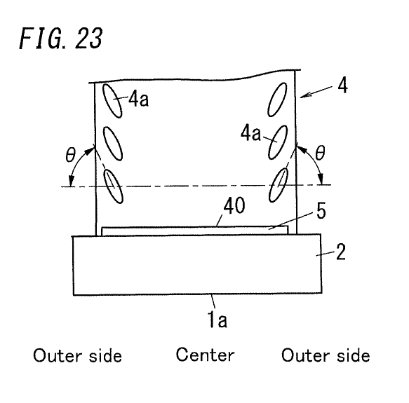

In an example, under a condition where voltage is not applied between the first transparent electrode 5 and the second transparent electrodes 6, the liquid crystal molecules 4a of the liquid crystal layer 4 have pretilt angles θ between an incident surface 40 and long axes of the molecules 4a (see FIG. 23) so that each of the molecules 4a is inclined from a center 3ac to an outer side (arc 3b) of a corresponding divided region 3ab. The incident surface 40 is included in either one of the first transparent electrode 5 and the second transparent electrodes 6, which faces a light source 20a. In the example of FIG. 22, the incident surface 40 is on a side of the first transparent electrode 5.

In a specific example, the liquid crystal molecule 4a has a negative dielectric anisotropy, and the liquid crystal molecules 4a are in a homeotropic alignment (see FIG. 3A), and the pretilt angle θ is preferably in a range of 80° to 89.9°, and more preferably 85° or more, and 89° or less. With the liquid crystal molecules 4a having pretilt angles in the above range, orientation changing directions (rotation directions) of the liquid crystal molecules 4a can be aligned (i.e., the liquid crystal molecules 4a rotates in same directions) when an electric field is applied thereto.

In a specific example, the liquid crystal molecule 4a has a positive dielectric anisotropy, and the liquid crystal molecules 4a are in a homogeneous alignment (see FIG. 4A), and the pretilt angle θ is preferably in a range of 0.1° to 10°, and more preferably 1° or more, and 5° or less. With the liquid crystal molecules 4a having pretilt angles in the above range, orientation changing directions (rotation directions) of the liquid crystal molecules 4a can be aligned (i.e., the liquid crystal molecules 4a rotates in same directions) when an electric field is applied thereto.

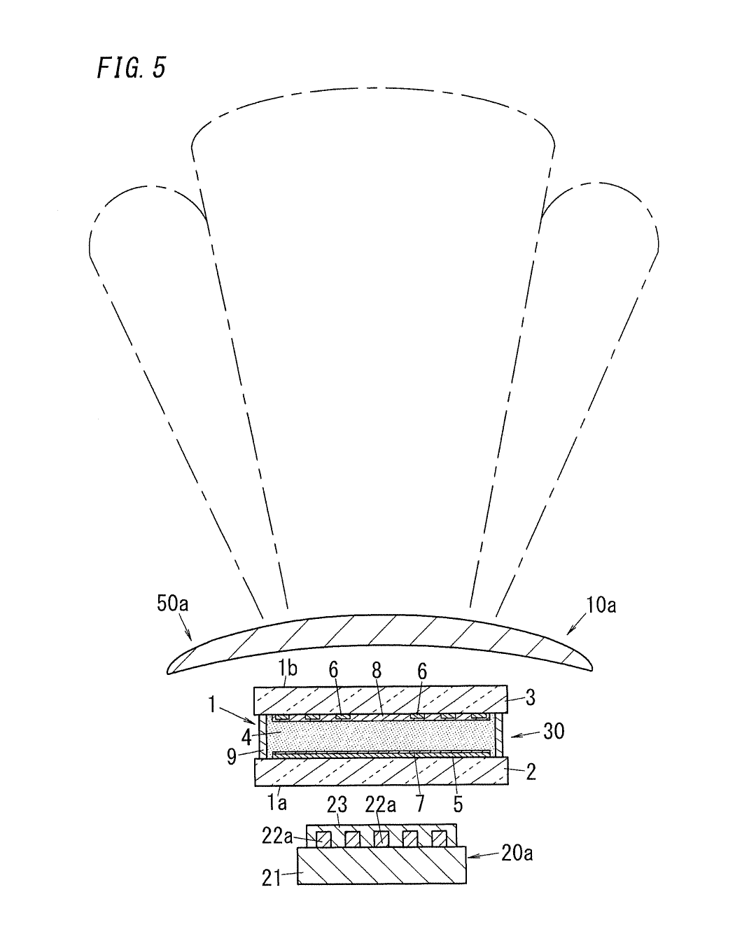

FIG. 5 shows a schematic diagram of a lamp device 10a including the liquid crystal lens 1.

The lamp device 10a includes a light source 20a and a lens 30. The lens 30 is for adjusting distribution of light from the light source 20a. In the lamp device 10a, the lens 30 is the liquid crystal lens 1. Accordingly, the lamp device 10a can provide enhanced flexible adjustment to light distribution.

Preferably, the lamp device 10a includes a protective cover 50a for protecting the light source 20a and the liquid crystal lens 1. The protective cover 50a is disposed apart from the liquid crystal lens 1 and faces the surface (second surface) 1b, from which rays of light emerge, of the liquid crystal lens 1. Preferably, the protective cover 50a has a circular peripheral shape when viewed in the thickness direction of the liquid crystal lens 1.

The protective cover 50a is optically (i.e., in the visible light range) transparent. The protective cover 50a has, in a visible light range, a total luminous transmittance of preferably 60% or more, further preferably 70% or more, and yet further preferably 80% or more. The total luminous transmittance can be determined according to a method defined in ISO 13468-1.

Dashed-dotted lines in FIG. 5 schematically show light distribution areas of light emitted from the lamp device 10a through the protective cover 50a. The light distribution area by the ordinary ray is illustrated as a middle dashed-dotted line area in FIG. 5. Right and left areas in FIG. 5 schematically indicate areas to be illuminated by the extraordinary ray.

The light source 20a is disposed directly below the liquid crystal lens 1. Accordingly, with the lamp device 10a, it is possible to adjust distribution of light from the light source 20a by the liquid crystal lens 1. In the lamp device 10a, preferably, the optical axis of the liquid crystal lens 1 under the initial state where electric field is not applied is parallel to that of the light source 20a.

As shown in FIGS. 5 to 8, the light source 20a includes a mounting substrate 21, light emission elements 22a mounted on the mounting substrate 21, and a wavelength conversion layer 23 covering the light emission elements 22a.

The mounting substrate 21 is a substrate on which the light emission elements 22a are mounted. “Mounting” includes disposing and mechanically connecting, and electrically connecting, the light emission elements 22a.

The mounting substrate 21 has a rectangular planar shape, but not limited thereto. The planar shape of the mounting substrate 21 may be a polygon other than the rectangle, a circle, or the like.

The mounting substrate 21 includes a support and conductors. The conductors are formed on a surface of the support to have a predetermined pattern, and the light emission elements 22a are electrically connected thereto. The support is made of a ceramic substrate, for example. Accordingly, the light source 20a has an improved heat discharging performance and can achieve higher output of the light, compared to a case where the support is made of a resin substrate. Examples of the ceramic substrate include an alumina substrate, an aluminum nitride substrate, and the like. Alternatively, the support may include a metal plate and an electrically insulating layer formed on a surface of the metal plate. Examples of the metal plate include an aluminum substrate, a copper substrate, and the like. In this case, the mounting substrate 21 can be made of a metal-based printed wiring board.

The light emission elements 22a are mounted on the mounting substrate 21 with a flip chip mounting, but mounting method thereof on the mounting substrate 21 is not limited thereto.

In the light source 20a, the light emission elements 22a are connected in series to each other, but not limited thereto. In the light source 20a, the light emission elements 22a may be connected in parallel to each other, or may have a connecting structure including series connection and parallel connection. In the light source 20a, the light emission elements 22a may be divided into different groups, and the groups may be individually controlled. The conductors of the mounting substrate 21 have desired pattern according to the connection profile of the light emission elements 22a.

Each of the light emission elements 22a is an LED chip. The LED chip may be a blue LED chip configured to emit a blue light. The blue light LED chip may be a GaN-based LED chip including a c-plane sapphire substrate as a substrate (substrate for crystal growth). The c-plane sapphire substrate indicates a sapphire substrate having a principal surface for growing GaN-based crystal of (0001) plane.

The wavelength conversion layer 23 is made of a mixture of the transparent material and the wavelength conversion material for wavelength-converting the light emitted from the light emission elements 22a to emit the converted light.

Examples of the transparent material for the wavelength conversion layer 23 include optically transparent resin, glass, and the like. Examples of the optically transparent resin include silicone resin, acrylic resin, epoxy resin, and the like.

The wavelength conversion material for the wavelength conversion layer 23 may be a yellow phosphor. The yellow phosphor is a phosphor that converts the wavelength of the light emitted from the light emission elements 22a to emit yellow light, which is different in the wavelength from the light of the light emission elements 22a. Examples of the yellow phosphor include Ce³⁺-doped Yttrium Aluminum Garnet (YAG), Eu²⁺-doped oxynitride phosphor, and the like. Examples of the Ce³⁺-doped YAG include Y₃Al₅O₁₂:Ce³⁺ and the like. Examples of the Eu²⁺-doped oxynitride phosphor include SrSi₂O₂N₂:Eu²⁺ and the like. In the wavelength conversion layer 23, the wavelength conversion material is dispersed in the transparent material. The wavelength conversion material may include a single kind of phosphors, or two or more kinds of phosphors having different emission spectra. The wavelength conversion layer 23 covers the light emission elements 22a. The wavelength conversion layer 23 may be formed by a screen printing, a dispense method, or the like.

Preferably, the positions of the light emission elements 22a and the shape of the wavelength conversion layer 23 are determined such that the light source 20a has a circular light distribution area in a plane perpendicular to the optical axis of the light source 20a. In other words, it is preferable that the positions of the light emission elements 22a and the shape of the wavelength conversion layer 23 are determined such that the light source 20a has a circular light distribution area at the surface (first surface) 1a, to which rays of light strike, of the liquid crystal lens 1. The positions of the light emission elements 22a are desirably determined based on the number of light emission elements 22a, the light distribution property of the light emission element 22a, and the like. Preferably, the wavelength conversion layer 23 has a circular planar shape.

Preferably, the light source 20a is located inside an outer circumference of a vertical projection domain (vertical projection domain onto a plane perpendicular to the thickness direction of the liquid crystal lens 1) of the second transparent substrate 3, projected in the thickness direction of the liquid crystal lens 1. In FIG. 8, dashed-two dotted lines indicate outer circumferences of the vertical projection domains of the second transparent substrate 3 and the second transparent electrode 6, projected in the thickness direction of the liquid crystal lens 1.

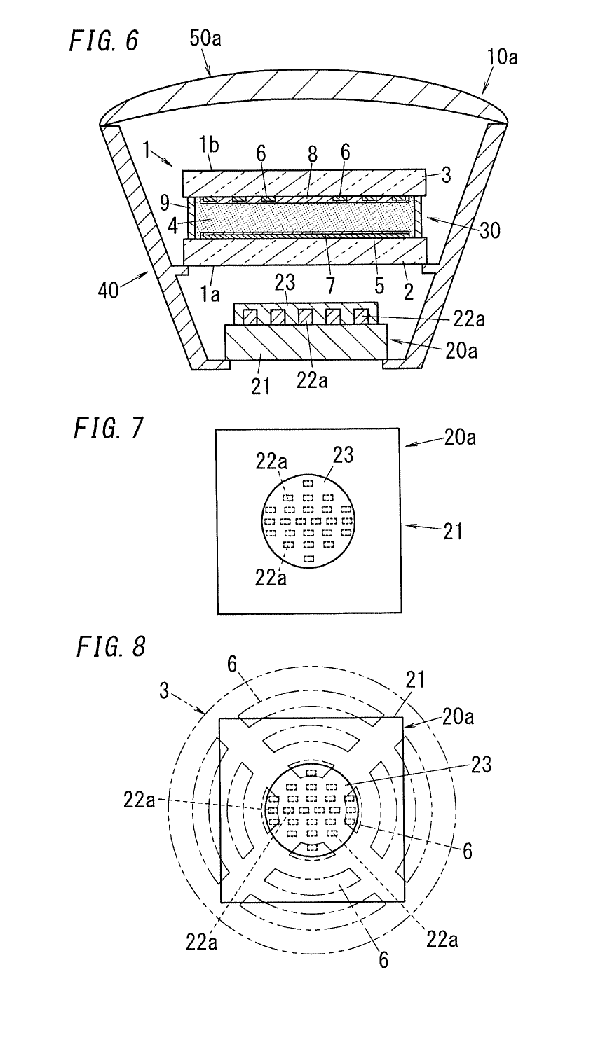

Preferably, the lamp device 10a includes a device body 40 in which the light source 20a and the liquid crystal lens 1 are housed, as shown in FIG. 6.

Preferably, the device body 40 is shaped like a box (in the embodiment, reversed circular truncated cone) with an opened side. Examples of material for the device body 40 include aluminum, aluminum alloy, stainless steel, resin, and the like.

Preferably, the protective cover 50a has a shape that closes the opened side of the device body 40.

Preferably, in the lamp device 10a, the device body 40 and the protective cover 50a form a housing, an inside space of which is filled with inert gas. Examples of the inert gas include N₂ gas, Ar gas, mixture of N₂ gas and Ar gas, and the like. In the lamp device 10a, the inside space of the housing may be vacuum.

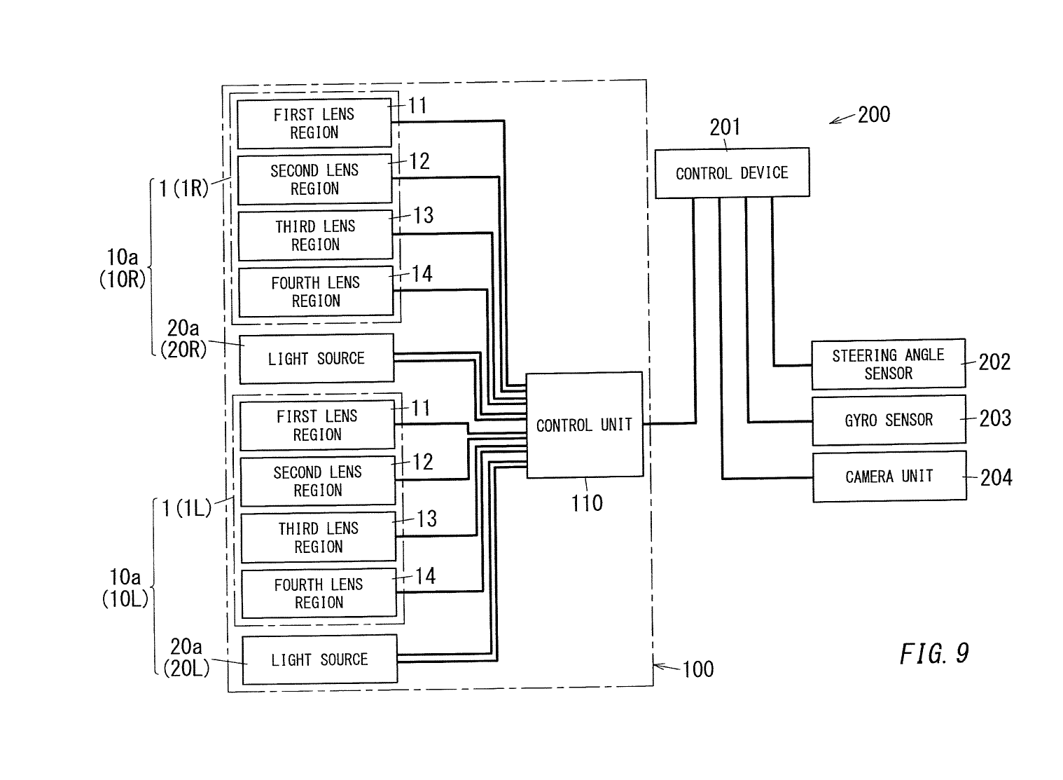

FIG. 9 is a schematic diagram of a control system 200 including a lighting device 100 that includes the lamp device 10a. The lighting device 100 and the control system 200 are explained below with reference to FIGS. 9 to 18.

The lighting device 100 includes the lamp device 10a and a control unit 110 configured to control a planar distribution of an electric filed to be applied to the liquid crystal lens 1. Accordingly, the lighting device 100 can provide enhanced flexible adjustment to light distribution.

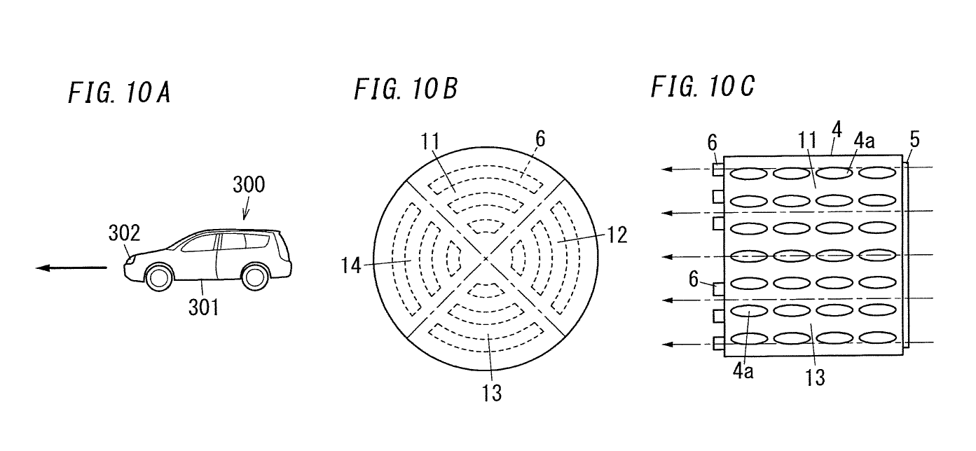

The control system 200 is installed in a vehicle 300 (see FIGS. 10A, 11B, 12A, 13, 15, 16A and 16B). The vehicle 300 is an automobile for traveling on a road. The lamp device 10a is installed as a headlight 302 in the vehicle 300. In detail, the vehicle 300 includes a headlight 302 installed on a left front corner of the vehicle 300 (hereinafter, referred to as “left headlight 302L”) and a headlight 302 installed on a right front corner of the vehicle 300 (hereinafter, referred to as “right headlight 302R”), i.e., two lamp devices 10a. The headlight 302 is a main-beam headlight. The main-beam headlight is configured to give a desired light before the vehicle 300. Note that “right” and “left” are respectively based on direction of a driver on a driver's seat of the vehicle 300. Hereinafter, for convenience of the explanation, the lamp device 10a as the left headlight 302L is also called “lamp device 10L”, and the lamp device 10a as the right headlight 302R is also called “lamp device 10R”. Also, the light source 20a in the lamp device 10L is also called “light source 20L”, and the light source 20a in the lamp device 10R is also called “light source 20R”. Also, the liquid crystal lens 1 in the lamp device 10L is also called “liquid crystal lens 1L”, and the liquid crystal lens 1 in the lamp device 10R is also called “liquid crystal lens 1R”.

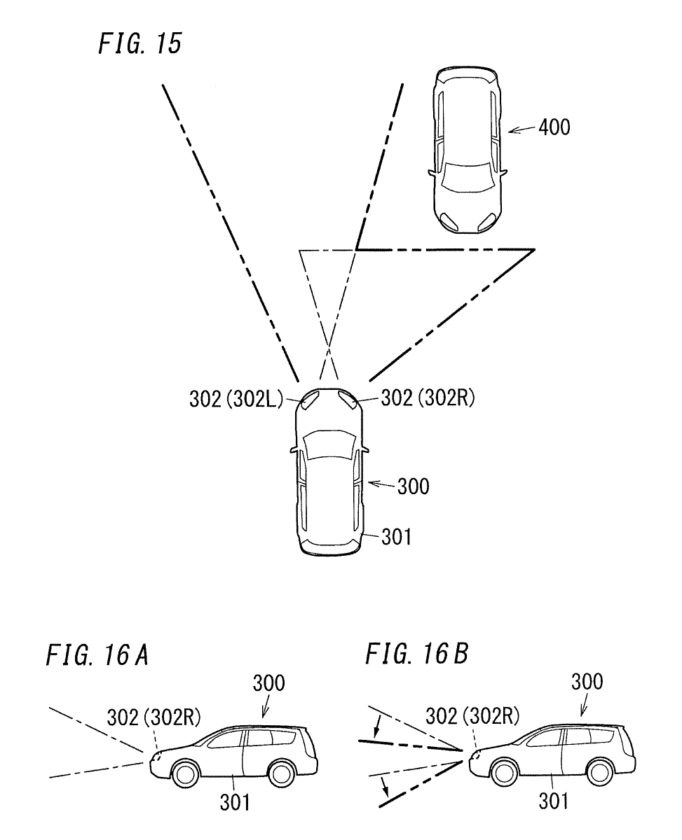

The lighting device 100 is configured to be controlled by a control device 201 in the vehicle 300, for example. The control device 201 may be an electronic control unit (ECU) for controlling the engine of the vehicle 300, for example. The control system 200 includes a steering angle sensor 202, a gyro sensor 203, and a camera unit 204. The steering angle sensor 202 is configured to sense a steering angle of the vehicle 300. The gyro sensor 203 is configured to sense an attitude angle of the vehicle body 301 of the vehicle 300. The camera unit 204 is configured to take an image before the vehicle 300. In the control system 200, the steering angle sensor 202, the gyro sensor 203, and the camera unit 204 are connected to the control device 201. The camera unit 204 is provided for sensing the presence of oncoming cars 400 (see FIG. 15) and the like. The control device 201 may be connected to a controller area network (CAN), as an onboard network system, of the vehicle. Note that the attitude angle indicates an angle between the main plane of the vehicle body 301 and the horizontal ground.

The control unit 110 includes a first drive circuit for driving the light source 20a and a second drive circuit for driving the liquid crystal lens 1. The first drive circuit is configured to supply a drive current to the light source 20a. The second drive circuit is configured to supply a drive voltage to the liquid crystal lens 1. The second drive circuit may include the driver 1001 and the controller 1002. The liquid crystal lens 1 includes first to fourth lens regions 11 to 14 (see FIG. 9) respectively corresponding to four divided regions 3ab (first to fourth regions 3ab1 to 3ab4). The first lens region 11 corresponds to the region 3ab1, and includes the two or more second transparent electrodes 6 in a divided region 3ab in an upper side in FIG. 2A. The second lens region 12 corresponds to the second region 3ab1, and includes the two or more second transparent electrodes 6 in a divided region 3ab in a right side in FIG. 2A. The third lens region 13 corresponds to the third region 3ab3, and includes the two or more second transparent electrodes 6 in a divided region 3ab in a lower side in FIG. 2A. The fourth lens region 14 corresponds to the fourth region 3ab4, and includes the two or more second transparent electrodes 6 in a divided region 3ab in a left side in FIG. 2A.

The control device 201 has, as operation modes of the headlights 302, first to third operation modes. According to the first operation mode the distribution of light of the headlights 302 is controlled based on the attitude angle of the vehicle body 301 sensed by the gyro sensor 203. According to the second operation mode, the distribution of light of the headlights 302 is controlled based on the steering angle sensed by the steering angle sensor 202. In other words, the second operation mode is “Adaptive Front-lighting System (AFS)” mode. According to the third operation mode, the distribution of light of the headlights 302 is controlled based on the detection result of the camera unit 204 about presence or absence of oncoming cars.

The first operation mode will be described with reference to FIGS. 10A, 10B, 10C, 11A, 11B, 11C, 12A, 12B and 12C.

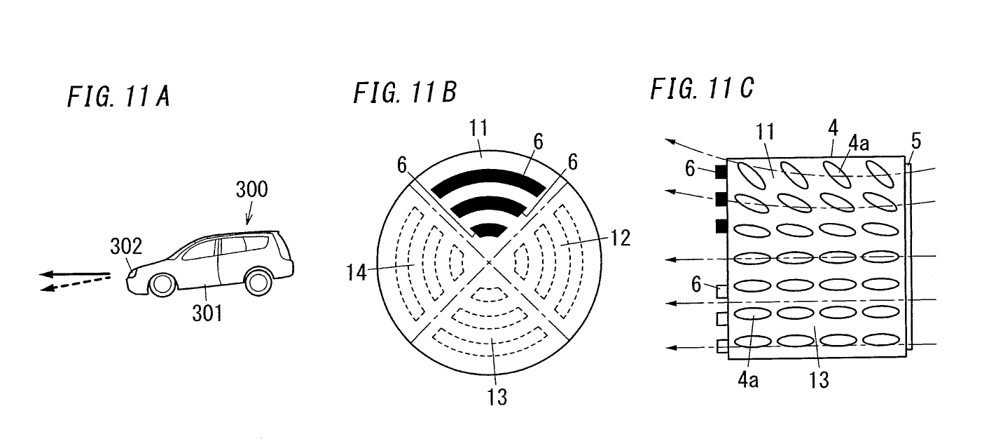

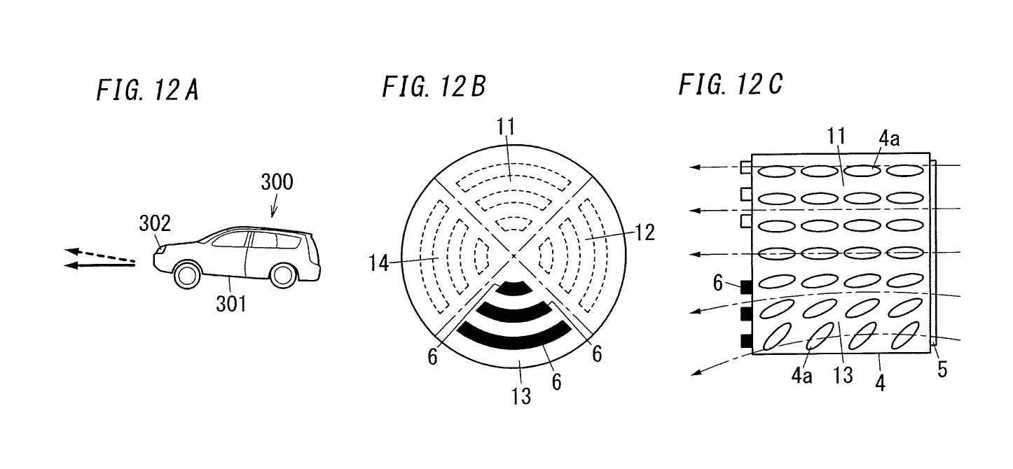

In FIGS. 10A, 11A, 12A, solid arrows indicate light centers of the headlights 302 of the vehicle 300 adjusted by the control device 201. In FIGS. 11A and 12A, broken lines indicate virtual light centers of the headlights 302 of the vehicle 300 when the control device 201 does not operate in the first operation mode. FIGS. 10B, 11B and 12B show schematic images (layout) of the second transparent electrodes 6 as seen from a side of the light source 20a. Note that, in FIGS. 10B, 11B and 12B, second transparent electrodes 6 to which voltages are applied are colored black, and other second transparent electrodes 6 to which no voltage is applied are shown by broken lines. FIGS. 10C, 11C and 12C show schematic sections of the liquid crystal lens 1 including the liquid crystal layer 4, the first transparent electrode 5 and the second transparent electrodes 6, which are taken along vertical lines of FIGS. 10B, 11B and 12B respectively. In FIGS. 10C, 11C and 12C, second transparent electrodes 6 to which voltages are applied are colored black, and other second transparent electrodes 6 to which no voltage is applied are colored white. In FIGS. 10C, 11C and 12C, dashed-dotted lines schematically indicate propagating directions of rays of light passing through the liquid crystal lens 1.

According to the first operation mode, when the vehicle body 301 is not tilted as shown in FIG. 10A (i.e., when the sensed attitude angle indicates that the vehicle body 301 is not tilted with respect to the horizontal ground), the control device 201 does not apply voltages to the second transparent electrodes 6 of the liquid crystal lens 1 as shown in FIG. 10B, and thereby does not change the light distribution by the liquid crystal lens 1 as shown in FIG. 10C.

According to the first operation mode, when the sensed attitude angle indicates that the vehicle body 301 is obliquely inclined downward (see FIG. 11A), the control device 201 applies voltages between the first transparent electrode 5 as a ground and the second transparent electrodes 6 in the first lens region 11, as shown in FIG. 11B. According to the control system 200, the light distribution is changed according to the first lens region 11, and as a result it is possible to provide more suitable light to the driver.

According to the first operation mode, when the sensed attitude angle indicates that the vehicle body 301 is obliquely inclined upward (see FIG. 12A), the control device 201 applies voltages between the first transparent electrode 5 as a ground and the second transparent electrodes 6 in the third lens region 13, as shown in FIG. 12B. According to the control system 200, the light distribution is changed according to the third lens region 13, and as a result it is possible to provide more suitable light to the driver.

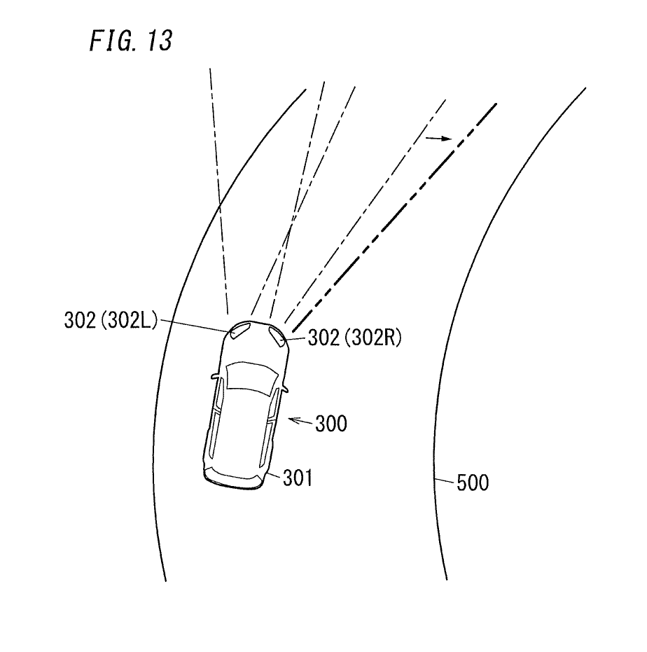

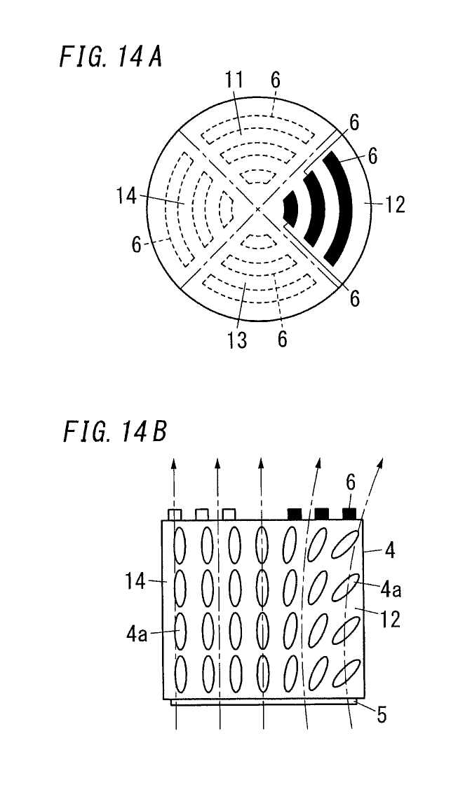

The second operation mode will be described with reference to FIGS. 13, 14A and 14B.

In FIG. 13, dashed-dotted lines indicate radiation area of light from the headlights 302 of the vehicle 300 when the control device 201 does not operate in the second operation mode. Also, dashed-two dotted lines indicate radiation area of light from the headlights 302 of the vehicle 300 when the liquid crystal lens 1 is controlled as shown in FIG. 14A based on the output signal of the steering angle sensor 202. FIG. 14A shows a schematic image (layout) of the second transparent electrodes 6 as seen from a side of the light source 20a. In FIG. 14A, second transparent electrodes 6 to which voltages are applied are colored black, and other second transparent electrodes 6 to which no voltage is applied are shown by broken lines. FIG. 14B shows a schematic section of the liquid crystal lens 1 including the liquid crystal layer 4, the first transparent electrode 5 and the second transparent electrodes 6, which is taken along a horizontal line of FIG. 14A. In FIG. 14B, second transparent electrodes 6 to which voltages are applied are colored black, and other second transparent electrodes 6 to which no voltage is applied are colored white.

The output signal of the steering angle sensor 202 varies according to the operation on the steering wheel of the vehicle 300 by the drive.

When the driver steers right in the right-hand curve 500 as shown in FIG. 13, the control system 200 applies voltages between the first transparent electrode 5 as a ground and the second transparent electrodes 6 in the second lens region 12, as shown in FIG. 14A. According to the control system 200, the light distribution is changed according to the second lens region 12, and as a result it is possible to provide more suitable light to the driver. Note that, when the driver steers left in the left-hand curve, the control system 200 applies voltages between the first transparent electrode 5 as a ground and the second transparent electrodes 6 in the fourth lens region 14, and accordingly the light distribution is changed according to the fourth lens region 14.

The third operation mode will be described with reference to FIGS. 15, 16A, 16B, 17A, 17B, 18A and 18B.

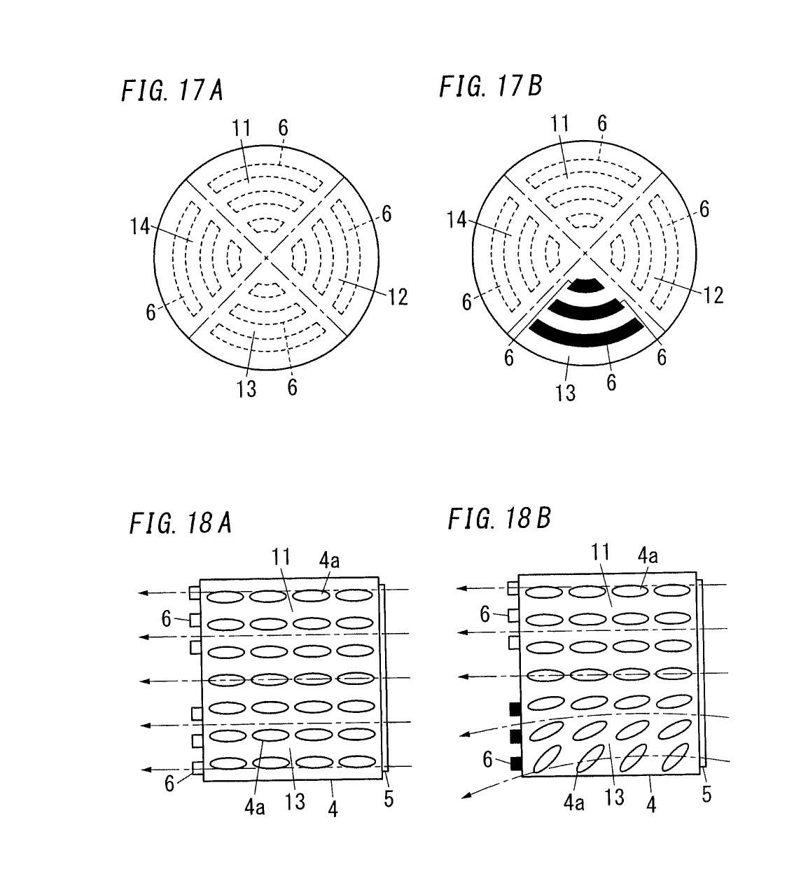

In FIG. 15, dashed-two dotted lines indicate radiation area of light from the right and left headlights 302R and 302L of the vehicle 300 when presence of an oncoming car 400 is detected by the camera unit 204. Dashed-dotted lines in FIG. 15 indicate radiation area covered with both of the right and left headlights 302R and 302L. In FIGS. 16A and 16B, dashed-dotted lines indicate radiation area of light from the right headlight 302R of the vehicle 300, when the presence of an oncoming car 400 is not detected by the camera unit 204. In FIG. 16B, dashed-two dotted lines indicate radiation area of light from the right headlight 302R of the vehicle 300, when the presence of an oncoming car 400 is detected by the camera unit 204 and the control by the third operation mode is performed. FIG. 17A shows a schematic image (layout) of the second transparent electrodes 6 of the lamp device 10L as seen from a side of the light source 20L. FIG. 17B shows a schematic image (layout) of the second transparent electrodes 6 of the lamp device 10R as seen from a side of the light source 20R. In FIGS. 17A and 17B, second transparent electrodes 6 to which voltages are applied are colored black, and other second transparent electrodes 6 to which no voltage is applied are shown by broken lines. FIG. 18A shows a schematic section of the liquid crystal lens 1L of the lamp device 10L including the liquid crystal layer 4, the first transparent electrode 5 and the second transparent electrodes 6, which is taken along a vertical line of FIG. 17A. In FIG. 18A, second transparent electrodes 6 to which no voltage is applied are colored white. FIG. 18B shows a schematic section of the liquid crystal lens 1R of the lamp device 10R including the liquid crystal layer 4, the first transparent electrode 5 and the second transparent electrodes 6, which is taken along a vertical line of FIG. 17A. In FIG. 18B, second transparent electrodes 6 to which voltages are applied are colored black, and other second transparent electrodes 6 to which no voltage is applied are colored white. In FIGS. 18A and 18B, dashed-dotted lines schematically indicate propagating directions of light passing through the liquid crystal lenses 1.

According to the control system 200, when an oncoming car 400 on the right front of the vehicle 300, as shown in FIG. 15, is detected by the camera unit 204, the light distribution is changed according to the third lens region 13 in the lamp device 10R of the right headlight 302R. Accordingly, the amount of light striking the oncoming car 400 can be reduced, and it is possible to avoid the driver of the oncoming car 400 suffering the glare of the headlights.

### Embodiment 2

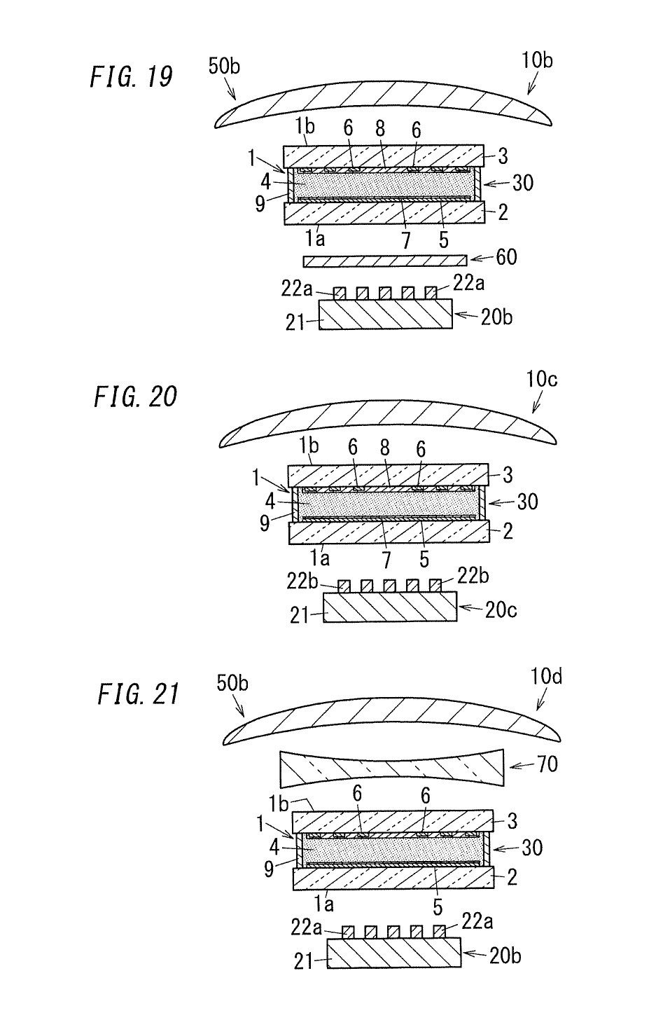

A lamp device 10b according to the present embodiment is explained with reference to FIG. 19. However, constituent elements similar to those of the lamp device 10a of Embodiment 1 are assigned with same reference numerals, and explanation thereof will be properly omitted.

The lamp device 10b differs from the lamp device 10a of Embodiment 1 in that a light source 20b does not include the wavelength conversion layer 23 described in Embodiment 1, that a polarization plate 60 is disposed between the light source 20b and a liquid crystal lens 1, and that a protective cover 50b is made of a mixture of transparent material and wavelength conversion material.

The light source 20b includes a mounting substrate 21 and light emission elements 22a, as with the lamp device 10a of Embodiment 1.

Examples of the transparent material for the protective cover 50b include optically transparent resin, glass, and the like. The wavelength conversion material for the protective cover 50b may be a yellow phosphor.

According to the combination of the polarization plate 60 and the light source 20b, it is possible to control the lamp device 10b so that only extraordinary rays enter the liquid crystal lens 1.

The polarization plate (linear polarizer) 60 is an optical device for converting a non-polarized light into a linearly-polarized light. The polarization plate 60 splits the incident light into two beams of polarized components orthogonal to each other, and, for example, transmits one component and absorbs the other component.

The lamp device 10b of the present embodiment includes the polarization plate 60 disposed between the light source 20b and the liquid crystal lens 1, and accordingly it is effectively control the light distribution by the liquid crystal lens 1.

### Embodiment 3

A lamp device 10c according to the present embodiment is explained with reference to FIG. 20. However, constituent elements similar to those of the lamp device 10b of Embodiment 2 are assigned with same reference numerals, and explanation thereof will be properly omitted.

The lamp device 10c differs from the lamp device 10b of Embodiment 2 in that each of light emission elements 22b of a light source 20c is a solid-state light emitting element configured to emit a light having linearly polarized component, and that the lamp device 10c does not include the polarization plate 60.

Examples of the solid-state light emitting element configured to emit a polarized light include: a laser diode; a GaN-based LED produced on a substrate for crystal growth having a non-polar principal surface, such as an m-plane sapphire substrate and an m-plane GaN substrate; and the like.

According to the lamp device 10c of the present embodiment, it is possible to effectively control the light distribution by the liquid crystal lens 1 without the polarization plate 60 in the lamp device 10b described in Embodiment 2.

### Embodiment 4

A lamp device 10d according to the present embodiment is explained with reference to FIG. 21. However, constituent elements similar to those of the lamp device 10b of Embodiment 2 are assigned with same reference numerals, and explanation thereof will be properly omitted.

The lamp device 10d differs from the lamp device 10b of Embodiment 2 in that an optical lens 70 is disposed between a liquid crystal lens 1 and a protective cover 50b for enlarging the angle between an optical axis of a light source 20b and rays of light refracted by the liquid crystal lens 1, and that the lamp device 10d does not include the polarization plate 60.

The optical lens 70 may be a diverging lens. Examples of the diverging lens include a biconcave lens and the like.

Since the optical lens 70 is disposed between the liquid crystal lens 1 and the protective cover 50b, the lamp device 10d of the present embodiment can have further wide range of light distribution area.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A liquid crystal lens comprising:
a first transparent substrate;
a second transparent substrate;
a liquid crystal layer disposed between the first transparent substrate and the second transparent substrate;
a first transparent electrode disposed between the first transparent substrate and the liquid crystal layer; and
second transparent electrodes disposed between the second transparent substrate and the liquid crystal layer and facing the first transparent electrode, wherein
at least one second transparent electrode of the second transparent electrodes is disposed in each of divided regions into which a surface region, facing the first transparent substrate, of the second transparent substrate is divided.

2. The liquid crystal lens according to claim 1, wherein
the divided regions respectively have circular sector shapes into which a circle is divided,
in each of the divided regions, two or more second transparent electrodes of the second transparent electrodes are arranged along a radial direction of the circle, and
in each of the divided regions, the two or more second transparent electrodes are shaped like arcs along an arc of its own circular sector shape, and have longer arc lengths as their own positions are closer to the arc of its own circular sector shape.

3. The liquid crystal lens according to claim 2, wherein
the divided regions include first to fourth regions respectively have quadrant shapes into which the circle is divided,
in each of the first to fourth regions, two or more second transparent electrodes of the second transparent electrodes are arranged along a radial direction of the circle, and
in each of the first to fourth regions, the two or more second transparent electrodes are shaped like arcs along an arc of its own quadrant shape, and have longer arc lengths as their positions are closer to the arc of its own quadrant shape.

4. A lamp device comprising:
a light source; and
a lens for adjusting distribution of light from the light source, wherein
the lens is the liquid crystal lens according to claim 1.

5. A lighting device comprising:
the lamp device according to claim 4; and
a control unit configured to control a planar distribution of an electric field to be applied to the liquid crystal lens.

6. A liquid crystal lens device comprising:
the liquid crystal lens according to claim 2;
a driver configured to apply voltages between the second transparent electrodes and the first transparent electrode, individually; and
a controller configured to control the driver.

7. The liquid crystal lens device according to claim 6, wherein
either one of the first transparent electrode and the second transparent electrodes includes an incident surface, and
under a condition where voltage is not applied between the first transparent electrode and the second transparent electrodes, liquid crystal molecules of the liquid crystal layer have pretilt angles between the incident surface and long axes of the molecules so that each of the molecules is inclined from a center to an outer side of a corresponding divided region.

8. The liquid crystal lens device according to claim 7, wherein the liquid crystal molecule has a negative dielectric anisotropy, and the pretilt angle is in a range of 80° to 89.9°.

9. The liquid crystal lens device according to claim 7, wherein the liquid crystal molecule has a positive dielectric anisotropy, and the pretilt angle is in a range of 0.1° to 10°.

10. A lighting device comprising:
the liquid crystal lens device according to claim 7; and
a light source facing the liquid crystal lens, wherein
the incident surface is defined as either one side of the first transparent electrode and the second transparent electrodes, facing the light source.
